(19) United States
(12) Patent Application Publication
(10) Pub. No.: US 2019/0034904 A1
(43) Pub. Date: Jan. 31, 2019

(54) INFORMATION PROCESSING APPARATUS, INFORMATION PROCESSING METHOD, AND NON-TRANSITORY STORAGE MEDIUM

(71) Applicant: NEC Corporation, Tokyo (JP)

(72) Inventors: Dai KINNO, Tokyo (JP); Kota IWAMOTO, Tokyo (JP); Shinichi MATSUMOTO, Tokyo (JP); Yoshihiro ITOU, Tokyo (JP); Shinya YAMASAKI, Tokyo (JP); Kanako TAGA, Tokyo (JP)

(73) Assignee: NEC Corporation, Tokyo (JP)

(21) Appl. No.: 16/071,673

(22) PCT Filed: Nov. 24, 2016
(86) PCT No.: PCT/JP2016/084745

§ 371 Date: Jul. 20, 2018

(30) Foreign Application Priority Data
Jan. 21, 2016 (JP) 2016-009603

(51) Int. Cl. G06Q 20/20; G06Q 30/02; G06Q 20/04; G06K 9/32; G06K 9/00

(52) U.S. Cl. CPC G06Q 20/208; G06Q 30/0226; G06Q 30/0238; G06K 2209/01; G06K 9/3258; G06K 9/00624; G06K 9/00442; G06Q 20/045

(57) ABSTRACT

A checkout apparatus (10) includes: an image data acquisition unit (11) that acquires data of an image; a product recognition unit (12) that recognizes, using a feature value of an exterior of each of a plurality of products registered in a product feature value storage unit (14) and the data of the image, a product in the image; a medium recognition unit (15) that recognizes, using a feature value of an exterior of each of payment media and/or point accumulation media used to accumulate a point in accordance with payment which are registered in a medium feature value storage unit (16) and the data of the image, a payment medium and/or a point accumulation medium in the image; and a payment processing unit (17) that performs a payment process using a recognition result by the medium recognition unit (15).

### TECHNICAL FIELD

The present invention relates to an information processing apparatus, an information processing method, and a program.

### BACKGROUND ART

Cash registers (for example, a point of sale (POS) register) are widely used in convenience stores, supermarkets, and other stores. In conventional art, registration work for products to be registered in cash registers at the time of checkout has been performed by reading product codes attached to products with a predetermined reader or operating operation objects (operation buttons, touch panel display apparatuses, or the like) included in the cash registers. There is a desire for technologies for efficiently performing registration works. Related technologies are disclosed in Patent Documents 1 to 3.

Patent Document 1 discloses an information processing apparatus that includes a first imaging unit, a recognition unit, and a determination unit. The first imaging unit images a placement surface of a placement platform on which an object is placed from a plurality of different imaging directions. The recognition unit recognizes an object corresponding to an object image for each first captured image by reading a feature value of the object image indicating an object contained in the first captured image from each of the first captured images captured in each of the plurality of imaging directions by the first imaging unit and comparing the feature value of each object stored in advance. The determination unit determines a recognition result of the object placed on the placement platform based on a recognition result of the object image for each first captured image. In the invention, various kinds of information are output through a display apparatus or a printer.

Patent Document 2 discloses a product reading apparatus that includes a display unit, a frame line display unit, a correction reception unit, a frame line correction unit, a product recognition unit, and an output unit. The display unit displays an image captured by an imaging unit. The frame line display unit displays a frame line surrounding a product contained in the image in the image displayed on the display unit. The correction reception unit receives an instruction to correct a frame line. The frame line correction unit corrects a frame line on a screen in response to the correction instruction. The product recognition unit recognizes a product contained in the image within the frame line. The output unit outputs information regarding the product recognized by the product recognition unit. In the invention, various kinds of information are also output through a display apparatus or a printer.

Patent Document 3 discloses an apparatus including a conveyer belt that transports a product, a starting button that starts an operation, a display apparatus that gives an instruction to perform work, a height measurement apparatus that measures the height of the product, an imaging apparatus that images the product, a first counter that performs counting when the height measurement apparatus and the imaging apparatus detect products, a barcode scanner that reads and decodes a barcode from a passing product by varying a focal distance or the like, a second counter that counts the number of products subjected to a registration process, and a POS terminal that processes an image from the imaging apparatus to determine the position, size, or the like of a product, performs a registration process based on product data of the scanner, and determines registration completion when the counted values of the first and second counters are identical after an ending button is operated. In the invention, various kinds of information are also output through a display apparatus or a printer.

### RELATED DOCUMENT

### Patent Document

[Patent Document 1] Japanese Laid-open Patent Publication No. 2013-54673

[Patent Document 2] Japanese Laid-open Patent Publication No. 2013-175890

[Patent Document 3] Japanese Laid-open Patent Publication No. H7-320146

### SUMMARY OF THE INVENTION

### Technical Problem

As disclosed in Patent Documents 1 to 3, an improvement in efficiency of registration work is expected by performing product registration using an image recognition technology.

However, in a checkout process, in addition to registration work other work such as a payment process is performed. In the payment process, kinds of work such as delivery of a payment medium (for example, a credit card, vouchers, bills, coins, or a prepaid card) for payment, an operation on a checkout apparatus using the payment medium, delivery of a point card, and an operation on a checkout apparatus using the point card are performed. For this reason, even though registration work is streamlined, there is still a room for improvement in efficiency of work in the whole checkout process.

An object of the invention is to provide a mechanism for solving the foregoing problems.

### Solution to Problem

According to an aspect of the invention, there is provided an information processing apparatus including: an image data acquisition unit that acquires data of an image; a product recognition unit that recognizes, using a feature value of an exterior of each of a plurality of products registered in a product feature value storage unit and the data of the image, a product in the image; a medium recognition unit that recognizes, using a feature value of an exterior of each of payment media and/or point accumulation media used to accumulate a point in accordance with payment which are registered in a medium feature value storage unit and the data of the image, a payment medium and/or a point accumulation medium in the image; and a payment processing unit that performs a payment process using a recognition result by the medium recognition unit.

According to another aspect of the invention, there is provided an information processing method executed by a computer, the method including: an image data acquisition step of acquiring data of an image; a product recognition step of recognizing, using a feature value of an exterior of each of a plurality of products registered in a product feature value storage unit and the data of the image, a product in the image; a medium recognition step of recognizing, using a feature value of an exterior of each of payment media and/or point accumulation media used to accumulate a point in accordance with payment which are registered in a medium feature value storage unit and the data of the image, a payment medium and/or a point accumulation medium in the image; and a payment processing step of performing a payment process using a recognition result in the medium recognition step.

According to still another aspect of the invention, there is provided a program causing a computer to function as: an image data acquisition unit that acquires data of an image; a product recognition unit that recognizes, using a feature value of an exterior of each of a plurality of products registered in a product feature value storage unit and the data of the image, a product in the image; a medium recognition unit that recognizes, using a feature value of an exterior of each of payment media and/or point accumulation media used to accumulate a point in accordance with payment which are registered in a medium feature value storage unit and the data of the image, a payment medium and/or a point accumulation medium in the image; and a payment processing unit that performs a payment process using a recognition result by the medium recognition unit.

### Advantageous Effects of Invention

According to the invention, a technology for improving efficiency of a checkout process is realized.

### BRIEF DESCRIPTION OF THE DRAWINGS

The above-described purposes, other purposes, features, and advantages will become more apparent from preferred exemplary embodiments to be described below and the following drawings appended therein.

FIG. 1 is a diagram conceptually illustrating an example of a hardware configuration of an apparatus according to an exemplary embodiment.

FIG. 2 is a diagram illustrating an application example of a checkout apparatus according to the exemplary embodiment.

FIG. 3 is an exemplary functional block diagram illustrating the checkout apparatus according to the exemplary embodiment.

FIG. 4 is a diagram schematically illustrating an example of information registered in a feature value storage unit according to the exemplary embodiment.

FIG. 5 is a diagram schematically illustrating an example of information registered in a product information storage unit according to the exemplary embodiment.

FIG. 6 is a diagram schematically illustrating an example of information registered in a medium feature value storage unit according to the exemplary embodiment.

FIG. 7 is a flowchart illustrating an example of a flow of processes of the checkout apparatus according to the exemplary embodiment.

FIG. 8 is an exemplary functional block diagram illustrating the checkout apparatus according to the exemplary embodiment.

FIG. 9 is a diagram illustrating an application example of the checkout apparatus according to the exemplary embodiment.

### DESCRIPTION OF EXEMPLARY EMBODIMENTS

First, an example of a hardware configuration of a checkout apparatus (an information processing apparatus) according to exemplary embodiments (first to third exemplary embodiments) will be described. Each functional constituent unit of the checkout apparatus may be realized with hardware (for example, a hard wired electronic circuit) realizing each functional constituent unit or may be realized in combination of hardware and software (for example, a combination of an electronic circuit and a program controlling the electronic circuit).

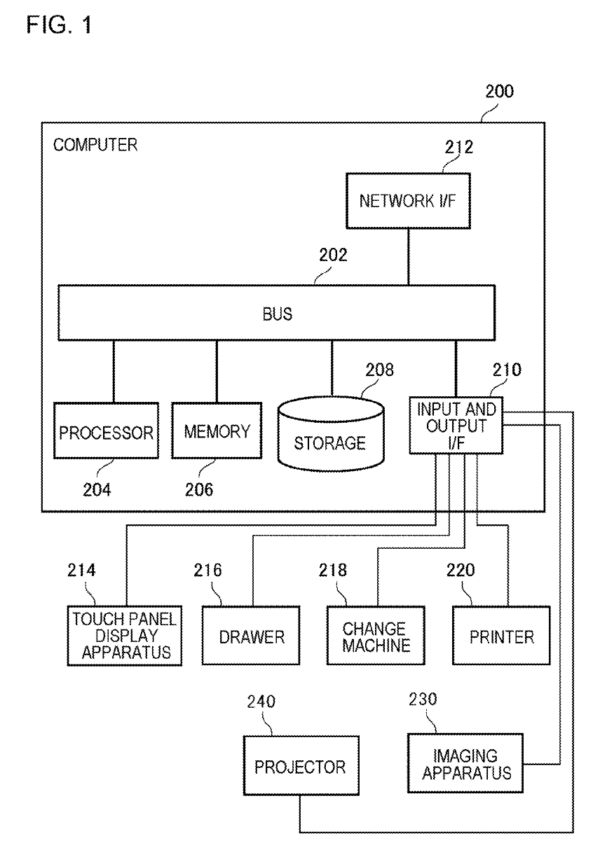

FIG. 1 is a diagram exemplifying a hardware configuration of the checkout apparatus according to an exemplary embodiment. The hardware configuration may be realized using a dedicated apparatus designed for a register terminal or may be realized using a general-purpose apparatus such as a personal computer (PC) or a portable terminal.

A computer 200 includes a bus 202, a processor 204, a memory 206, a storage 208, an input and output interface 210, and a network interface 212. The bus 202 is a data transmission path through which the processor 204, the memory 206, the storage 208, the input and output interface 210, and the network interface 212 transmit and receive data one another. However, a method of connecting the processor 204 and the like to each other is not limited to connection by the bus. The processor 204 is an arithmetic processing apparatus such as a central processing unit (CPU) or a graphics processing unit (GPU). The memory 206 is a memory such as a random access memory (RAM) or a read-only memory (ROM). The storage 208 is a storage apparatus such as a hard disk, a solid-state drive (SSD), or a memory card. The storage 208 may be a memory such as RAM or a ROM.

The input and output interface 210 is an interface which connects the computer 200 to an input and output apparatus. For example, a touch panel display apparatus 214, a drawer 216, a change machine 218, a printer 220, an imaging apparatus 230, a projector 240, and the like are connected to the input and output interface 210. The touch panel display apparatus 214 is used, for example, to manually input a price of a product. The touch panel display apparatus 214 displays various kinds of information such as information regarding products registered as objects for checkout. The drawer 216 stores coins and bills. The change machine 218 includes an input port through which purchase money is inserted and a discharge port through which a change is discharged. The printer 220 issues a receipt or the like. The imaging apparatus 230 images a still image and/or a moving image. The projector 240 projects a predetermined image. An input interface such as a keyboard other than the touch panel display apparatus 214 may be connected to the computer 200.

The network interface 212 is an interface that connects the computer 200 to an external apparatus so that communication is possible. The network interface 212 may be a network interface that makes connection to a wired line or may be a network interface that makes connection with a wireless line. For example, the computer 200 that realizes a checkout apparatus is connected to a store server or the like that manages various apparatuses installed in a store via a network.

The storage 208 stores a program module that realizes each function (each functional unit) of the checkout apparatus. The processor 204 realizes each function corresponding to each program module by executing each program module. Here, the processor 204 may load each module into the memory 206 to execute each module or may not load each module into the memory 206 to execute each module when each module is executed.

The hardware configuration of the checkout apparatus is not limited to the configuration illustrated in FIG. 1. For example, each program module may be stored in the memory 206. In this case, the computer 200 may not include the storage 208. The computer 200 may not necessarily be connected to another apparatus so that communication is possible via a network. Accordingly, the computer 200 may not include the network interface 212. In a case where the checkout apparatus is not used for a process of paying purchase money, the checkout apparatus may not include the drawer 216, the change machine 218, and the printer 220. The checkout apparatus may not include the imaging apparatus 230 as long as an image captured by the imaging apparatus 230 can be acquired. In this case, the checkout apparatus is configured to be able to communicate with the imaging apparatus 230 to acquire image data from the imaging apparatus 230. The checkout apparatus may not include the projector 240.

Hereinafter, exemplary embodiments will be described. A functional block diagram used to describe the following exemplary embodiments illustrates a block of a functional unit rather than a configuration of a hardware unit. In the drawings, each apparatus is described so that the apparatus is configured with one apparatus, but a configuration mechanism is not limited thereto. That is, the apparatus may be divided physically or may be divided logically. The same reference numerals are given to the same constituent elements and the description thereof will not be appropriately repeated.

### First Exemplary Embodiment

First, an overview of the checkout apparatus according to the exemplary embodiment will be described. The checkout apparatus according to the exemplary embodiment can perform product registration through an image recognition technology. That is, the checkout apparatus analyzes data of an image captured so that a placement surface of a placement platform on which a product for checkout is placed is contained, and recognizes one product or a plurality of products shown in the image. In this recognition, an exterior feature of each product is used. The checkout apparatus registers one recognized product or a plurality of recognized products as products for checkout.

The checkout apparatus analyzes the data of the image and recognizes a payment medium and a point accumulation medium shown in an image. Further, the checkout apparatus recognizes text information that the recognized medium has using a text recognition technology. Then, the checkout apparatus performs a payment process using a recognition result of the payment medium or the point accumulation medium and a text recognition result.

In this way, the checkout apparatus according to the exemplary embodiment recognizes a payment medium or a point accumulation medium, and text information that the medium has using an image recognition technology adopted for improvement in efficiency of product registration, and performs a payment process using a recognition result. As a result, the improvement in efficiency of the payment process is realized.

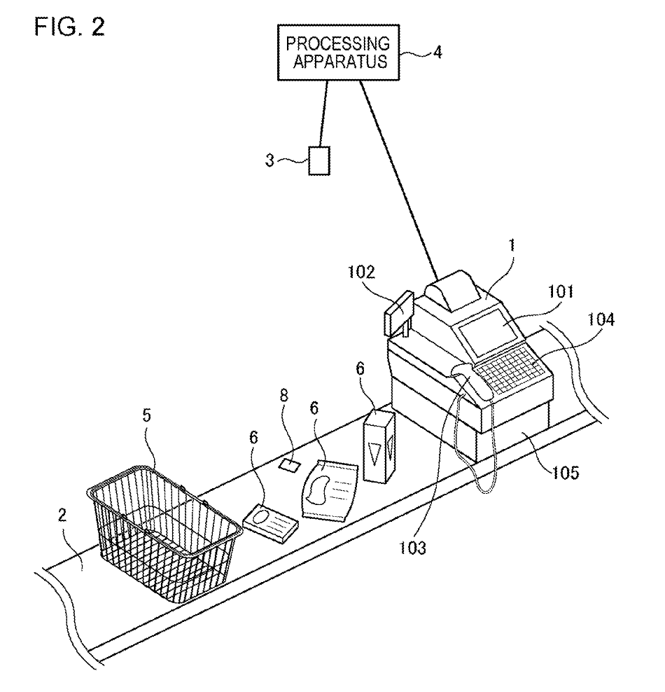

Next, an application example of the checkout apparatus according to the exemplary embodiment will be described with reference to FIG. 2. The checkout apparatus includes a registration apparatus 1 and a processing apparatus 4. The checkout apparatus may further include an imaging apparatus 3. In the drawing, the registration apparatus 1 and the processing apparatus 4 are separately described, but these apparatuses may be integrated physically and/or logically. The imaging apparatus 3 and the processing apparatus 4 are separately described, but these apparatuses may be integrated physically and/or logically.

The hardware configuration of FIG. 1 is an example in which the registration apparatus 1 and the processing apparatus 4 are integrated logically. The registration apparatus 1 and the processing apparatus 4 include the computer 200 illustrated in FIG. 1. Then, the registration apparatus 1 includes the touch panel display apparatus 214, the drawer 216, the change machine 218, and the printer 220 illustrated in FIG. 1. The imaging apparatus 3 corresponds to the imaging apparatus 230 illustrated in FIG. 1.

The imaging apparatus 3 is connected to the processing apparatus 4 so that communication is possible. The registration apparatus 1 is connected to the processing apparatus 4 so that communication is possible. A communication standard is a design factor. Either wired or wireless communication may be performed.

The imaging apparatus 3 has a function of imaging a moving image and/or a still image. The imaging apparatus 3 may continuously image data of a moving image. Besides, the imaging apparatus 3 may capture a still image intermittently (also periodically). In this case, the imaging apparatus 3 can perform imaging at a predetermined timing (for example, a timing instructed by a worker) determined in advance.

For example, the imaging apparatus 3 is installed at a predetermined position to image a placement surface of the placement platform 2. An installation position is a design factor. For example, the imaging apparatus 3 may be installed immediately above or obliquely above the placement surface of the placement platform 2 to image the placement surface from the direction. Besides, the imaging apparatus 3 may be installed on the placement surface of the placement platform 2 to image the placement surface from a transverse direction. Besides, the placement platform 2 may include a transparent member and/or a semitransparent member with transparency and the imaging apparatus 3 may be installed below the placement platform 2, as illustrated. In this case, the imaging apparatus 3 images the placement surface from underneath the placement platform 2.

The processing apparatus 4 acquires image data from the imaging apparatus 3. Then, the processing apparatus 4 recognizes a product 6 contained in an image by analyzing the image. The processing apparatus 4 recognizes a medium 8 which is a payment medium and/or a point accumulation medium through image analysis. Subsequently, the processing apparatus 4 recognizes text information that the recognized medium 8 has through image analysis. Then, the processing apparatus 4 transmits a recognition result to the registration apparatus 1.

The registration apparatus 1 has a function of registering the product 6 for checkout using the recognition result received from the processing apparatus 4. That is, the registration apparatus 1 registers the product 6 recognized by the processing apparatus 4. The registration apparatus 1 has a function of performing a payment process using the recognition result received from the processing apparatus 4. That is, the registration apparatus 1 performs a payment process using the medium 8 recognized by the processing apparatus 4 and the text information that the medium 8 has.

The illustrated registration apparatus 1 includes a display apparatus 101, a display apparatus 102, a code reader 103, operation buttons 104, and a drawer 105.

The display apparatus 101 is oriented toward the near side of the placement platform 2 (the side of a product registration worker) so that the worker performing registration work mainly views the display apparatus 101. Information regarding a checkout process, a warning, and the like are displayed on the display apparatus 101. The display apparatus 101 may be a touch panel display apparatus.

The display apparatus 102 is oriented toward the opposite side of the placement platform 2 (the side of a customer) so that a shopper mainly views the display apparatus 102. Information regarding the checkout process, an advertisement, and the like are displayed on the display apparatus 102. The display apparatus 102 may be a touch panel display apparatus.

The code reader 103 reads a product code (1-dimensional code, a 2-dimensional code, or the like) attached to each product 6. The plurality of operation buttons 104 corresponding to various products, numbers, and various functions (for example, subtotals) are used to input the various products, the numbers, and the various functions. As described above, in the exemplary embodiment, the product registration can be performed through the image recognition technology. Therefore, the code reader 103 and the operation buttons 104 are supplementarily used. Money, vouchers, and the like are accommodated in the drawer 105.

The registration apparatus 1 only need to have at least a function of registering a product 6 for checkout and a function of performing a payment process and the registration apparatus may not have at least some of the illustrated functions.

The illustrated registration apparatus 1 has a configuration on the assumption that a store staff operates the registration apparatus 1, but may have a configuration on the assumption that the registration apparatus 1 is operated by a shopper.

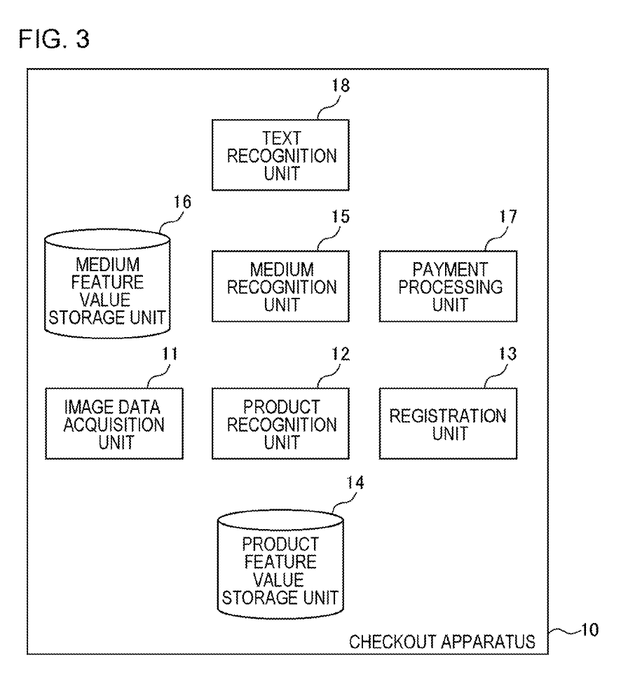

Next, a configuration of the checkout apparatus according to the exemplary embodiment will be described in detail. FIG. 3 is an exemplary functional block diagram illustrating the checkout apparatus 10 according to the exemplary embodiment. As illustrated, the checkout apparatus 10 includes an image data acquisition unit 11, a product recognition unit 12, a registration unit 13, a product feature value storage unit 14, a medium recognition unit 15, a medium feature value storage unit 16, a payment processing unit 17, and a text recognition unit 18.

The checkout apparatus 10 may not include at least one of the product feature value storage unit 14 and the medium feature value storage unit 16. In this case, another apparatus logically separated from the checkout apparatus 10 may include the storage unit (at least one of the product feature value storage unit 14 and the medium feature value storage unit 16). The checkout apparatus 10 is configured to communicate with the other apparatus and to be able to acquire the information stored in the storage unit (the product feature value storage unit 14 and the medium feature value storage unit 16).

As described above, the checkout apparatus 10 includes the registration apparatus 1 and the processing apparatus 4 illustrated in FIG. 2. The image data acquisition unit 11 is realized by the processing apparatus 4. The product recognition unit 12 is realized by the processing apparatus 4. The registration unit 13 is realized by the registration apparatus 1. The product feature value storage unit 14 may be realized by the processing apparatus 4. The medium recognition unit 15 is realized by the processing apparatus 4. The medium feature value storage unit 16 may be realized by the processing apparatus 4. The payment processing unit 17 is realized by the registration apparatus 1. The text recognition unit 18 is realized by the processing apparatus 4.

The image data acquisition unit 11 acquires data of an image captured so that the placement surface of the placement platform on which a product for checkout is placed is contained. The image data acquisition unit 11 acquires data of an image captured by the imaging apparatus 3 described with reference to FIG. 2 in real time.

The product recognition unit 12 recognizes one product or a plurality of products shown in the image using the data of the image acquired by the image data acquisition unit 11 (a recognition process). The product recognition unit 12 can recognize one product or a plurality of products in each frame by performing the recognition process for each frame.

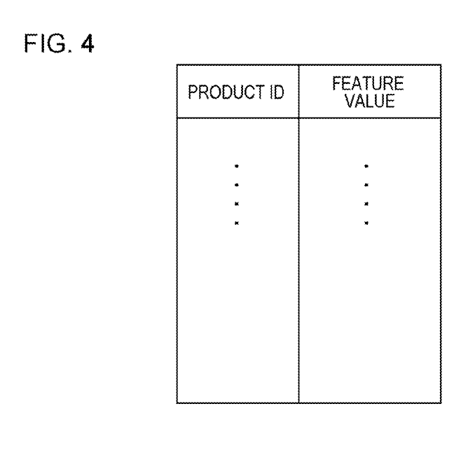

In the recognition process, the product recognition unit 12 uses the product feature value storage unit 14 in which a feature value of the exterior of each of a plurality of products is registered in advance. FIG. 4 is a diagram schematically illustrating an example of information stored in the product feature value storage unit 14. In the illustrated example, a product ID (identifier) for identifying each of a plurality of products is associated with a feature value of the exterior of each of the plurality of products. As the feature value, a shape, a color, a color distribution, or the like can be exemplified, but the invention is not limited thereto. The product feature value storage unit 14 may store a feature value of each of a plurality of exteriors when each product is observed in a plurality of directions, corresponding to each product.

An algorithm for product recognition performed by the product recognition unit 12 using the image data and the product feature value storage unit 14 is a design factor and all technologies can be adopted. For example, the technologies disclosed in Patent Documents 1 to 3 may be adopted.

Referring back to FIG. 3, the registration unit 13 registers one product or a plurality of products recognized by the product recognition unit 12 as a product for checkout. For example, the registration unit 13 may perform the product registration using a product information storage unit (not illustrated) in which product information regarding each of the plurality of products is registered in advance.

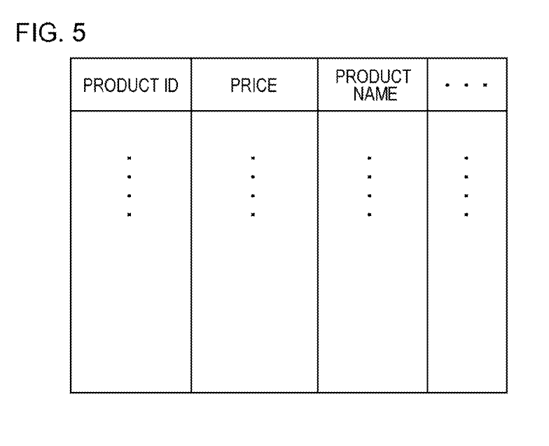

FIG. 5 is a diagram schematically illustrating an example of product information registered in the product information storage unit. A products ID and a name and a price of each product are associated with one another in the illustrated product information. The product information may not include some of them or may include another piece of information.

The checkout apparatus 10 may include the product information storage unit. Besides, another apparatus logically separated from the checkout apparatus 10 may include the product information storage unit. In the latter case, the checkout apparatus 10 is configured to communicate with the other apparatus and to be able to acquire the product information stored in the product information storage unit.

The registration unit 13 acquires the product information (for example, a name, a price, or the like) of one product or a plurality of products recognized by the product recognition unit 12 from the product information storage unit. Then, the registration unit 13 registers the acquired product information.

Referring back to FIG. 3, the medium recognition unit 15 recognizes one medium or a plurality of media (a payment medium and/or a point accumulation medium) shown in the image using the data of the image acquired by the image data acquisition unit 11.

The payment medium is a medium to be used for payment and corresponds to, for example, a credit card, a voucher, a point card, a discount coupon, bills, coins, or a prepaid card. The point accumulation medium is a medium used to accumulate points in accordance with payment (for example, a payment amount) and corresponds to, for example, a point card.

The same design is put on the same kind of credit card, the same kind of point card, the same kind of prepaid card, or the like to be viewable. Unique specific information (for example, a membership number) is attached to each of the same kinds of plurality of credit cards, the same kinds of plurality of point cards, and the same kinds of prepaid cards in a viewable manner. The same kind of credit card and the same kind of point card mean, for example, credit cards or point cards of which issuers (companies, local governments, or the like) are the same or point cards of which the kinds of point are the same.

The same design is put on the same kind of vouchers irrespective of amounts, and amounts are attached in a viewable manner in some cases. The same kind of vouchers means, for example, that issuers (companies, local governments, or the like) are the same.

The same design is put on the same kind of discount coupons in a viewable manner irrespective of discount content and the discount content (a discount amount, a discount rate, or the like) is attached in a viewable manner. The same kinds of discount coupons mean, for example, discount coupons of which issuers (companies, local governments, or the like) are the same.

Therefore, the medium recognition unit 15 can recognize each kind of medium on the basis of a feature (for example, a design feature) of the exterior of the payment medium or the point accumulation medium. The medium recognition unit 15 recognizes a medium using the medium feature value storage unit 16 in which a feature value of the exterior of one kind of payment medium or each of a plurality of kinds of payment media and/or a feature value of the exterior of one kind of point accumulation medium or each of a plurality of kinds of point accumulation media is registered in advance.

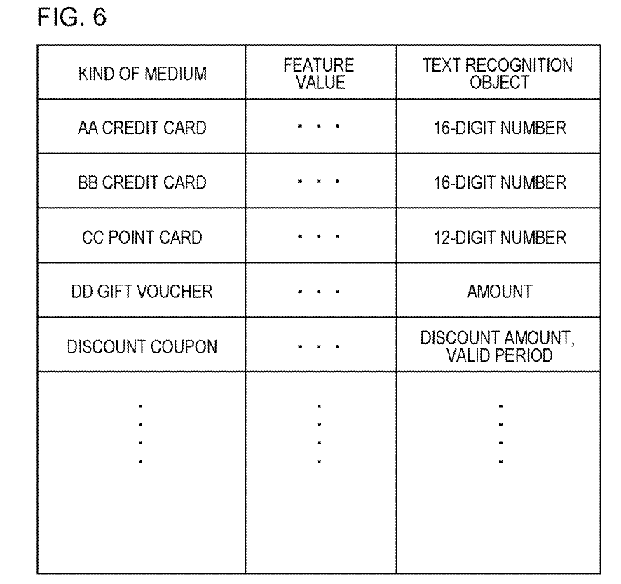

FIG. 6 schematically illustrates an example of information stored in the medium feature value storage unit 16. In the drawing, a kind of medium, a feature value of the exterior, and an object to be recognized in the text recognition process are associated with each other.

In the medium feature value storage unit 16, various kinds of payment media and/or various kinds of point accumulation media which can be used in each store are registered in advance. In a column of the kind of medium, information for identifying various kinds of payment media and various kinds of point accumulation media is described. Media such as credit cards, point cards, vouchers, discount coupons, and prepaid cards are classified in more detail in accordance with issuers (companies, local governments, or the like), kinds of points, or the like and feature values are registered.

In an illustrated column of the feature value, a feature value of the exterior of each of a plurality of kinds of payment media and/or a feature value of the exterior of each of a plurality of kinds of point accumulation media is described. The feature value relates to, for example, a design (a shape, a printed pattern, or the like) of a medium. A shape, a color, and a distribution of the color can be exemplified, but the invention is not limited thereto.

In a column of a text recognition object, information recognized by the text recognition unit 18 to be described below is described. The text recognition object is information used for the payment process performed using various kinds of media and is, for example, a card membership number attached to a credit card, a point card, a prepaid card, or the like, an amount described on a gift voucher, a discount amount described on a discount coupon, or a valid period.

An algorithm for medium recognition by the medium feature value storage unit 16 and the medium recognition unit 15 using image data is a design factor and any technology can be adopted. For example, the algorithm may be an algorithm similar to the product recognition unit 12.

The text recognition unit 18 recognizes text information in an area in the image in which the payment medium and/or the point accumulation medium is shown. The text recognition unit 18 can recognize text information using any text recognition technology.

For example, as illustrated in FIG. 6, in a case where information regarding the text recognition object is registered in advance to correspond to various kinds of media, the text recognition unit 18 can determine an object for which text is recognized on the basis of the information and a recognition result by the medium recognition unit 15. The text recognition unit 18 can perform the text recognition process in accordance with the determined object.

For example, when the text recognition object is an M-digit number, the text recognition unit 18 uses a template of “number” to search for a string of M numbers from the image. Besides, when the text recognition object is an amount or a discount amount, the text recognition unit 18 uses, for example, a template of text information used along with an amount such as “yen”, “¥”, “$” to search for the text information from the image. Thereafter, a number string (amount) before or after the recognized text information is searched for using the template of “number”. When the text recognition object is a valid period, the text recognition unit 18 uses a template of the text information such as “term” to search for the text information from the image. Thereafter, the text recognition unit 18 uses the template of “number” to search for a number string (valid period information such as day and year) near the recognized text information.

Referring back to FIG. 3, the payment processing unit 17 performs the payment process using the recognition result by the medium recognition unit 15 and the recognition result by the text recognition unit 18. Hereinafter, an example of the payment process will be described.

For example, when the medium recognition unit 15 can recognize a predetermined kind of credit card, the medium recognition unit 15 identifies a credit card company corresponding to the credit card (for example, the medium feature value storage unit 16 may retain information indicating a correspondent relation between various credit cards and credit card companies in advance). The payment processing unit 17 can transmit a membership number (a number string of predetermined digits), a payment amount and the like recognized by the text recognition unit 18 to a system of the identified credit card company to request the credit card company to approve payment.

Besides, when the medium recognition unit 15 recognizes a predetermined kind of point card and the text recognition unit 18 recognizes a membership number (a number string of predetermined digits), the payment processing unit 17 can transmit the recognized membership number, a payment amount, and the like to a system of a card company managing the recognized point card to request the card company to grant points.

Besides, when the medium recognition unit 15 recognizes a predetermined kind of point card or prepaid card and the text recognition unit 18 recognizes a membership number (a number string of predetermined digits), the payment processing unit 17 transmits the recognized membership number, a payment amount, and the like to a system of a card company managing the recognized point card or prepaid card to request the card company for payment based on accumulated points or a balance of a deposit previously made.

Besides, when the medium recognition unit 15 recognizes a predetermined kind of gift voucher and the text recognition unit 18 recognizes an amount, the payment processing unit 17 subtracts the amount of the gift voucher from a sum of registered payment amounts of products to calculate a balance amount. Thereafter, the balance amount may be output through the display apparatus 101 or the display apparatus 102.

Besides, when the medium recognition unit 15 recognizes a predetermined kind of discount coupon and the text recognition unit 18 recognizes a discount amount and a valid period, the payment processing unit 17 can check whether a current date is within the valid period by first comparing the recognized valid period to the current date. When the current date is within the valid period, a balance amount can be calculated by subtracting the amount of the gift voucher from the sum of the registered payment amounts of the products. Thereafter, the balance amount may be output through the display apparatus 101 or the display apparatus 102. Conversely, when the valid period is overdue, information indicating that the valid period is overdue may be output through the display apparatus 101 or the display apparatus 102.

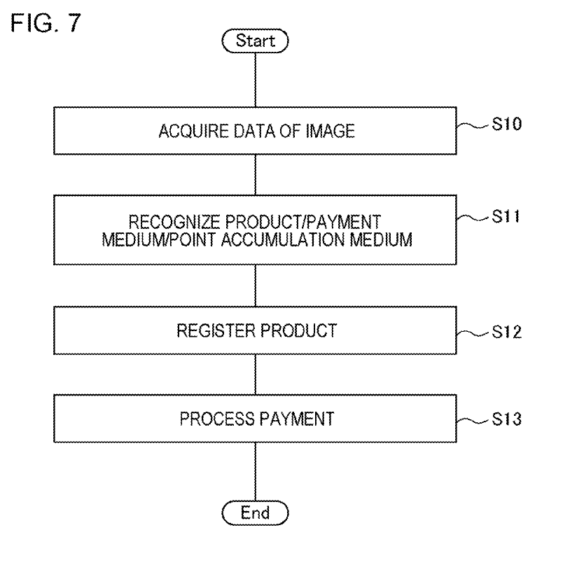

Next, an example of a flow of a process of the checkout apparatus 10 according to the exemplary embodiment will be described with reference to the application example of FIG. 2 and the flowchart of FIG. 7.

First, a shopper brows in a store and puts products 6 for purchase into a shopping basket 5. Thereafter, the shopper moves to a location of the checkout apparatus 10 for the checkout process.

A store staff who performs registration work places the products 6 contained in the shopping basket 5 at a predetermined position on the placement surface of the placement platform 2, as illustrated in FIG. 2. The shopper places the medium 8 on the placement surface. Thus, the products 6 and the medium 8 are shown in a captured image captured by the imaging apparatus 3.

Then, the image data acquisition unit 11 (the processing apparatus 4) acquires data of the image from the imaging apparatus 3 (S10).

In S11, the product recognition unit 12 (the processing apparatus 4) analyzes the data of the image and recognizes the product 6 shown in the image. The medium recognition unit 15 (the processing apparatus 4) analyzes the data of the image and recognizes the medium 8 shown in the image. The product 6 and the medium 8 may be recognized from the same frame or different frames. When the medium 8 is recognized, the text recognition unit 18 (the processing apparatus 4) searches an area in which the medium 8 is shown and recognizes predetermined text information. The recognition results are transmitted in sequence to the registration apparatus 1.

Specifically, when information indicating the product 6 recognized by the product recognition unit 12 is received as the received recognition result, the registration unit 13 (the registration apparatus 1) registers the product 6 as an object for checkout (S12).

When the registration work is completed for all the products 6 for purchase, the store staff operates the registration apparatus 1 to perform the checkout process, the payment process, or the like.

For example, the store staff performs a predetermined operation (for example, pressing of “a subtotal” button) on the operation button 104 to complete the registration work. Then, the payment processing unit 17 (the registration apparatus 1) performs the payment process using the received recognition result, specifically, the information indicating the kind of medium 8 recognized by the medium recognition unit 15 and the text information recognized by the text recognition unit 18 (S13). A specific example of the payment process has been described above.

In the foregoing example, the example in which S10, S11, S12, and S13 are performed in this order has been described, but the invention is not limited thereto. For example, after S10, only the recognition of the product 6 is performed in S11, and the product registration may be performed in S12 after S11. Thereafter, the data of the image may be acquired again (S10) and the medium 8 may be recognized based on the data of the image (S11). Thereafter, the payment process may be performed in S13.

The checkout apparatus 10 according to the above-described exemplary embodiment can perform the product registration through the image recognition process. Therefore, an improvement in efficiency of the product registration work is realized.

The checkout apparatus 10 according to the exemplary embodiment uses the image recognition technology adopted for the improvement in efficiency of the product registration to further perform recognition of the payment medium or the point accumulation medium and recognition of the text information that the payment medium or the point accumulation has. Then, the payment process can be performed using the recognition result. As a result, the improvement in efficiency of the payment process is realized.

For example, the checkout apparatus 10 according to the exemplary embodiment can recognize various kinds of credit cards and can further recognize information (the membership number or the like) unique to the various kinds of credit cards. Then, the payment process can be performed using the recognition result. In this case, omission of delivery of the credit card or simplification of an operation of reading card information into the registration apparatus 1 is realized. As a result, the improvement in efficiency of the payment process is realized.

Besides, the checkout apparatus 10 according to the exemplary embodiment can recognize various kinds of point cards and can further recognize information (the membership number or the like) unique to the various kinds of point cards. Then, the payment process such as granting of points can be performed using the recognition result. In this case, omission of delivery of the point card or simplification of an operation of reading card information into the registration apparatus 1 is realized. As a result, the improvement in efficiency of the payment process is realized.

Besides, the checkout apparatus 10 according to the exemplary embodiment can recognize various kinds of prepaid cards and can further recognize information (the membership number or the like) unique to the various kinds of prepaid cards. Then, the payment process can be performed using the recognition result. In this case, omission of delivery of the prepaid card or simplification of an operation of reading card information into the registration apparatus 1 is realized. As a result, the improvement in efficiency of the payment process is realized.

Besides, the checkout apparatus 10 according to the exemplary embodiment can recognize various kinds of gift vouchers and can further recognize the amounts of the recognized gift vouchers. Then, the payment process such as a process of subtracting the amount of the gift voucher from the payment amount to calculate a balance amount can be performed using the recognition result. In this case, omission of delivery of the gift voucher or omission of check of content (the amount or the like) of the gift voucher by the store staff is realized. As a result, the improvement in efficiency of the payment process is realized.

Besides, the checkout apparatus 10 according to the exemplary embodiment can recognize various kinds of discount coupons and can further recognize the content (discount amounts, discount rates, valid periods, or the like) of the recognized discount coupons. Then, the payment process such as a process of checking the valid period or a process of subtracting the discount amount from the payment amount to calculate a balance amount can be performed using the recognition result. In this case, omission of delivery of the discount coupon or omission of check of content (the discount amount, the discount rate, the valid period, or the like) of the discount coupon by the store staff is realized. As a result, the improvement in efficiency of the payment process is realized.

### Second Exemplary Embodiment

In the first exemplary embodiment, the example in which the payment process is performed using the recognition result of the payment medium or the point accumulation medium and the recognition result of the text information has been described. In the exemplary embodiment, an example in which the payment process is performed without performing the process of recognizing text information will be described.

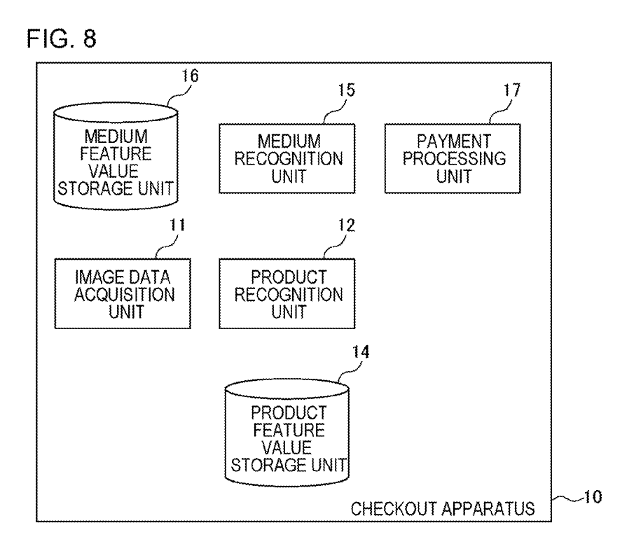

FIG. 8 is an exemplary functional block diagram illustrating the checkout apparatus 10 according to the exemplary embodiment. As illustrated, the checkout apparatus 10 includes the image data acquisition unit 11, the product recognition unit 12, the product feature value storage unit 14, the medium recognition unit 15, the medium feature value storage unit 16, and the payment processing unit 17. Although not illustrated, the checkout apparatus 10 may include the registration unit 13. The checkout apparatus 10 may not include at least one of the product feature value storage unit 14 and the medium feature value storage unit 16. The assumption of this case is the same as that of the first exemplary embodiment.

The configurations of the image data acquisition unit 11, the product recognition unit 12, the registration unit 13, and the product feature value storage unit 14 are the same as those of the first exemplary embodiment.

A medium recognized by the medium recognition unit 15 according to the exemplary embodiment is a voucher, a discount coupon, a bill, a coin, or the like.

For example, designs depending on issuers or amounts can be put on various vouchers having a different issuer and amount in a viewable manner. That is, even when the issuers are the same but the amounts are different, mutually different designs are put in some cases. The same kinds of vouchers according to the exemplary embodiment mean that the issuers or the amounts are the same.

Designs depending on issuers or discount content are put on various discount coupons having a different issuer or different discount content (discount amounts, discount rates, or the like) in a viewable manner. That is, even when the issuers are the same but the discount content are different, mutually different designs are put. The same kinds of discount coupons according to the exemplary embodiment mean that the issuers or the discount content are the same.

To each bill or each coin circulated in each nation, a design depending on an amount is put thereon in a viewable manner.

Therefore, the medium recognition unit 15 can recognize various kinds of money, various kinds of discount coupons, various bills, and various effects on the basis of features of the exteriors (for example, features of the designs) of the vouchers, the discount coupons, the bills, and the coins. The medium recognition unit 15 performs recognition of each medium using the medium feature value storage unit 16 in which a feature value of the exterior of one kind of voucher or each of a plurality kinds of money and/or a feature value of the exterior of one kind of discount coupon or each of a plurality kinds of discount coupons and/or a feature value of the exterior of one kind of bill or each of a plurality kinds of bills and/or a feature value of the exterior of one kind of coin or each of a plurality kinds of coins are registered in advance.

That is, the medium recognition unit 15 can recognize each voucher of each amount by using the medium feature value storage unit 16. The medium recognition unit 15 can recognize each discount coupon with each piece of discount content using the medium feature value storage unit 16. The medium recognition unit 15 can recognize each bill of each amount using the medium feature value storage unit 16. The medium recognition unit 15 can recognize each coin of each amount using the medium feature value storage unit 16. The other remaining configurations of the medium recognition unit 15 and the medium feature value storage unit 16 are the same as those of the first exemplary embodiment.

The payment processing unit 17 performs the payment process using each voucher of each amount, each discount coupon with each piece of discount content, each bill of each amount, and/or each coin of each amount recognized by the medium recognition unit 15. The content of the payment process is the same as that of the first exemplary embodiment. The other remaining configuration of the payment processing unit 17 is the same as that of the first exemplary embodiment.

When the medium recognition unit 15 recognizes bills or coins, the payment processing unit 17 calculates a sum of the amounts and inputs the calculated sum of the amounts as an amount tendered to the registration apparatus 1.

According to the above-described exemplary embodiment, it is possible to realize the same advantageous effects as the first exemplary embodiment. In the exemplary embodiment, various kinds of vouchers, various kinds of discount coupons, various kinds of bills, and/or various kinds of coins can be recognized and the payment process can be performed without performing the text recognition process. As a result, it is possible to realize a reduction in processing burden on a computer and shortening of a time necessary for the process.

### Third Exemplary Embodiment

A checkout apparatus 10 according to the exemplary embodiment includes a projection apparatus that projects an image related to a checkout process on a placement surface of a placement platform or a product.

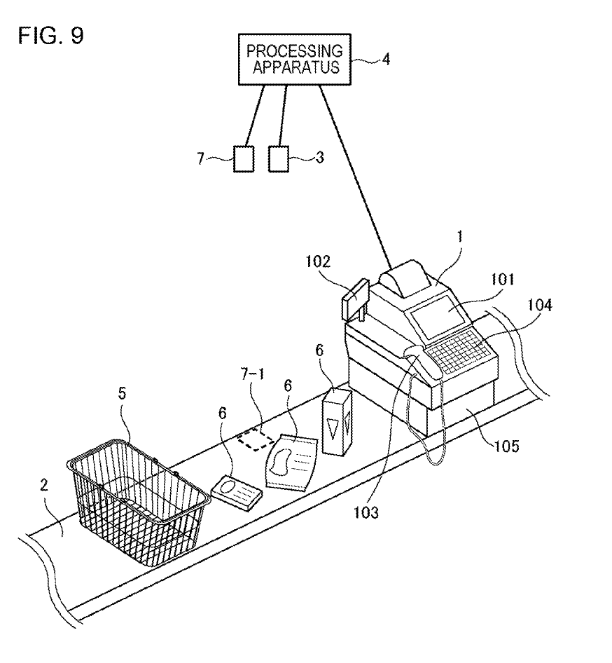

An example of application of the checkout apparatus according to the exemplary embodiment will be described with reference to FIG. 9. The checkout apparatus includes a registration apparatus 1, a processing apparatus 4, and a projection apparatus 7. The checkout apparatus may further include an imaging apparatus 3. The configurations of the registration apparatus 1 and the imaging apparatus 3 are the same as those of the first and second exemplary embodiments.

The projection apparatus 7 projects an image related to a checkout process on the placement surface of the placement platform 2 and/or the product 6. The projection apparatus 7 is installed at a predetermined position at which the projection can be performed. The installation position is a design factor. For example, the projection apparatus 7 may be installed immediately above or obliquely above the placement surface to project an image from the direction. Besides, the projection apparatus 7 may be installed on the placement surface to project the image from a transverse direction. Besides, the placement platform 2 may include a transparent member and the projection apparatus 7 may be installed below the placement platform 2. In this case, the projection apparatus 7 projects the image to the placement surface of the placement platform 2 from underneath the placement platform 2. The projection apparatus 7 includes the projector 240 illustrated in FIG. 1.

The processing apparatus 4 controls the projection apparatus 7. That is, the processing apparatus 4 transmits control information indicating the image to be projected or a position on which the image is projected to the projection apparatus 7. The projection apparatus 7 projects a predetermined image on the placement surface of the placement platform 2 or the product 6 in accordance with the control information. The other remaining configuration of the processing apparatus 4 is the same as that of the first and second exemplary embodiments.

The image to be projected by the projection apparatus 7 is configured in any form such as text, a number, a sign, or a figure. The image may be configured with many colors. The image may be a still image or may be a moving image.

For example, the projection apparatus 7 may project an image 7-1 indicating a location at which the payment medium or the point accumulation medium is placed, as illustrated in FIG. 9. Thus, a shopper can easily recognize the location at which this medium is placed.

The projection apparatus 7 may project a guide for placing the medium using text information. For example, the projection apparatus 7 may project text information such as “Here, put credit card or point card with membership number upward” on the placement platform 2 in addition to the image 7-1 illustrated in FIG. 9.

Besides, the projection apparatus 7 may project guidance information indicating that the payment process is performed through an image recognition process. For example, the projection apparatus 7 may project a moving image indicating that the payment process is performed through the image recognition process when the credit card or the point card is placed on the placement platform 2.

According to the above-described exemplary embodiment, it is possible to realize the advantageous effects similar to those of the first and second exemplary embodiments.

According to the exemplary embodiment, it is possible to project the guidance information for the payment process performed through the image recognition process to the placement platform 2. Therefore, a shopper can easily understand a process of the payment process or how to perform the process. In particular, since the location at which the payment medium or the point accumulation medium is placed can be directly indicated on the placement surface of the placement platform 2, the shopper can easily recognize the placement location.

Hereinafter, examples of reference exemplary embodiments are appended.

1. An information processing apparatus including:

an image data acquisition unit that acquires data of an image;

a product recognition unit that recognizes, using a feature value of an exterior of each of a plurality of products registered in a product feature value storage unit and the data of the image, a product in the image;

a medium recognition unit that recognizes, using a feature value of an exterior of each of payment media and/or point accumulation media used to accumulate a point in accordance with payment which are registered in a medium feature value storage unit and the data of the image, a payment medium and/or a point accumulation medium in the image; and

a payment processing unit that performs a payment process using a recognition result by the medium recognition unit.

2. The information processing apparatus described in 1, further including:

a text recognition unit that recognizes text information in an area in the image in which the payment medium and/or the point accumulation medium is shown,

in which the payment processing unit performs the payment process using a recognition result by the text recognition unit.

3. The information processing apparatus described in 2,

in which the same design is put on the same kind of payment medium and/or the same kind of point accumulation medium in a viewable manner, and unique specific information is attached to each of a plurality of payment media of the same kind and/or each of a plurality of point accumulation media of the same kind in a viewable manner,

in which a feature value of the design of each kind of payment medium and/or each kind of point accumulation medium is registered in the medium feature value storage unit,

in which the medium recognition unit recognizes the kind of the payment medium and/or the point accumulation medium, and

in which the text recognition unit recognizes the specific information.

4. The information processing apparatus described in 1,

in which the payment medium is a voucher of a predetermined amount and a design depending on an amount is put thereon in a viewable manner,

in which a feature value of each design depending on the amount is registered in the medium feature value storage unit, and

in which the medium recognition unit recognizes the voucher of the predetermined amount.

5. The information processing apparatus described in 2,

in which the payment medium is a voucher of a predetermined amount, the same design is put thereon in a viewable manner irrespective of an amount, and the amount is attached in a viewable manner,

in which a feature value of the design is registered in the medium feature value storage unit,

in which the medium recognition unit recognizes the voucher, and

in which the text recognition unit recognizes the amount.

6. The information processing apparatus described in 1,

in which the payment medium is a discount coupon and a design depending on discount content is put thereon in a viewable manner,

in which a feature value of each design depending on the discount content is registered in the medium feature value storage unit, and

in which the medium recognition unit recognizes the discount coupon of predetermined discount content.

7. The information processing apparatus described in 2,

in which the payment medium is a discount coupon, the same design is put thereon in a viewable manner irrespective of discount content, and the discount content is attached in a viewable manner,

in which a feature value of the design is registered in the medium feature value storage unit,

in which the medium recognition unit recognizes the discount coupon, and

in which the text recognition unit recognizes the discount content.

8. An information processing method executed by a computer, the method comprising:

an image data acquisition step of acquiring data of an image;

a product recognition step of recognizing, using a feature value of an exterior of each of a plurality of products registered in a product feature value storage unit and the data of the image, a product in the image;

a medium recognition step of recognizing, using a feature value of an exterior of each of payment media and/or point accumulation media used to accumulate a point in accordance with payment which are registered in a medium feature value storage unit and the data of the image, a payment medium and/or a point accumulation medium in the image; and

a payment processing step of performing a payment process using a recognition result in the medium recognition step.

8-2. The information processing method executed by a computer described in 8, the method including:

a text recognition step of recognizing text information in an area in the image in which the payment medium and/or the point accumulation medium is shown,

in which in the payment processing step, the payment process is performed using a recognition result in the text recognition step.

8-3. The information processing method described in 8-2,

in which the same design is put on the same kind of payment medium and/or the same kind of point accumulation medium in a viewable manner, and unique specific information is attached to each of a plurality of payment media of the same kind and/or each of a plurality of point accumulation media of the same kind in a viewable manner,

in which a feature value of the design of each kind of payment medium and/or each kind of point accumulation medium is registered in the medium feature value storage unit,

in which in the medium recognition step, the kind of the payment medium and/or the point accumulation medium is recognized, and

in which in the text recognition step, the specific information is recognized.

8-4. The information processing method described in 8,

in which the payment medium is a voucher of a predetermined amount and a design depending on an amount is put thereon in a viewable manner,

in which a feature value of each design depending on the amount is registered in the medium feature value storage unit, and

in which in the medium recognition step, the voucher of the predetermined amount is recognized.

8-5. The information processing method described in 8-2,

in which the payment medium is a voucher of a predetermined amount, the same design is put thereon in a viewable manner irrespective of an amount, and the price is attached in a viewable manner,

in which a feature value of the design is registered in the medium feature value storage unit,

in which in the medium recognition step, the voucher is recognized, and

in which in the text recognition step, the amount is recognized.

8-6. The information processing method described in 8,

in which the payment medium is a discount coupon and a design depending on discount content is put thereon in a viewable manner,

in which a feature value of each design depending on the discount content is registered in the medium feature value storage unit, and

in which in the medium recognition step, the discount coupon of predetermined discount content is recognized.

8-7. The information processing method described in 8-2,

in which the payment medium is a discount coupon, the same design is put thereon in a viewable manner irrespective of discount content, and the discount content is attached in a viewable manner,

in which a feature value of the design is registered in the medium feature value storage unit,

in which in the medium recognition step, the discount coupon is recognized, and

in which in the text recognition step, the discount content is recognized.

9. A program causing a computer to function as:

an image data acquisition unit that acquires data of an image;

a product recognition unit that recognizes, using a feature value of an exterior of each of a plurality of products registered in a product feature value storage unit and the data of the image, a product in the image;

a medium recognition unit that recognizes, using a feature value of an exterior of each of payment media and/or point accumulation media used to accumulate a point in accordance with payment which are registered in a medium feature value storage unit and the data of the image, a payment medium and/or a point accumulation medium in the image; and

a payment processing unit that performs a payment process using a recognition result by the medium recognition unit.

9-2. The program described in 9, causing the computer to further function as:

a text recognition unit that recognizes text information in an area in the image in which the payment medium and/or the point accumulation medium is shown,

in which the payment processing unit performs the payment process using a recognition result by the text recognition unit.

9-3. The program described in 9-2,

in which the same design is put on the same kind of payment medium and/or the same kind of point accumulation medium in a viewable manner, and unique specific information is attached to each of a plurality of payment media of the same kind and/or each of a plurality of point accumulation media of the same kind in a viewable manner,

in which a feature value of the design of each kind of payment medium and/or each kind of point accumulation medium is registered in the medium feature value storage unit,

in which the medium recognition unit recognizes the kind of the payment medium and/or the point accumulation medium, and

in which the text recognition unit recognizes the specific information.

9-4. The program described in 9,

in which the payment medium is a voucher of a predetermined amount and a design depending on an amount is put thereon in a viewable manner,

in which a feature value of each design depending on the amount is registered in the medium feature value storage unit, and

in which the medium recognition unit recognizes the voucher of the predetermined amount.

9-5. The program described in 9-2,

in which the payment medium is a voucher of a predetermined amount, the same design is put thereon in a viewable manner irrespective of an amount, and the amount is attached in a viewable manner,

in which a feature value of the design is registered in the medium feature value storage unit,

in which the medium recognition unit recognizes the voucher, and

in which the text recognition unit recognizes the amount.

9-6. The program described in 9,

in which the payment medium is a discount coupon and a design depending on discount content is put thereon in a viewable manner,

in which a feature value of each design depending on the discount content is registered in the medium feature value storage unit, and

in which the medium recognition unit recognizes the discount coupon of predetermined discount content.

9-7. The program described in 9-2,

in which the payment medium is a discount coupon, the same design is put thereon in a viewable manner irrespective of discount content, and the discount content is attached in a viewable manner,

in which a feature value of the design is registered in the medium feature value storage unit,

in which the medium recognition unit recognizes the discount coupon, and

in which the text recognition unit recognizes the discount content.

Priority is claimed on Japanese Patent Application No. 2016-009603, filed Jan. 21, 2016, the content of which is incorporated herein by reference.

1. An information processing apparatus comprising:
at least one memory configured to store one or more instructions; and
at least one processor configured to execute the one or more instructions to:
acquire data of an image;
recognize a product in the image by using the data of the image;
recognize, using a feature value of an exterior of at least one of each of payment media and point accumulation media used to accumulate a point in accordance with payment which are registered in the at least one memory and the data of the image, at least one of a payment medium and a point accumulation medium in the image;
perform a payment process using the recognition result; and
recognize both of the product and at least one of the payment medium and the point accumulation medium when the image includes both of the product and at least one of the payment medium and the point accumulation medium.

2. The information processing apparatus according to claim 1, wherein the at least one processor is further configured to:
recognize text information in an area in the image in which at least one of the payment medium and the point accumulation medium is shown, and
perform the payment process using the recognition result.

3. The information processing apparatus according to claim 2,
wherein the same design is put on the same kind of payment medium in a viewable manner, and unique specific information is attached to each of a plurality of payment media of the same kind in a viewable manner,
wherein a feature value of the design of each kind of payment medium is registered in the at least one memory,
wherein the at least one processor is further configured to:
recognize the kind of the payment medium and the specific information.

4. The information processing apparatus according to claim 1,
wherein the payment medium is a voucher of a predetermined amount and a design depending on an amount is put thereon in a viewable manner,
wherein a feature value of each design depending on the amount is registered in the at least one memory, and
wherein the at least one processor is further configured to recognize the voucher of the predetermined amount.

5. The information processing apparatus according to claim 2,
wherein the payment medium is a voucher of a predetermined amount, the same design is put thereon in a viewable manner irrespective of an amount, and the amount is attached in a viewable manner,
wherein a feature value of the design is registered in the at least one memory,
wherein the at least one processor is further configured to recognize the voucher and the amount.

6. The information processing apparatus according to claim 1,
wherein the payment medium is a discount coupon and a design depending on discount content is put thereon in a viewable manner,
wherein a feature value of each design depending on the discount content is registered in the at least one memory, and
wherein the at least one processor is further configured to recognize the discount coupon of predetermined discount content.

7. The information processing apparatus according to claim 2,
wherein the payment medium is a discount coupon, the same design is put thereon in a viewable manner irrespective of discount content, and the discount content is attached in a viewable manner,
wherein a feature value of the design is registered in the at least one memory,
wherein the at least one processor is further configured to recognize the discount coupon and the discount content.

8. An information processing method executed by a computer, the method comprising:
acquiring data of an image;
recognizing a product in the image by using the data of the image;
recognizing, using a feature value of an exterior of at least one of each of payment media and point accumulation media used to accumulate a point in accordance with payment which are registered in at least one memory and the data of the image, at least one of a payment medium and a point accumulation medium in the image;
performing a payment process using the recognition result; and
recognizing both of the product and at least one of the payment medium and the point accumulation medium when the image includes both of the product and at least one of the payment medium and the point accumulation medium.

9. A non-transitory storage medium storing a program causing a computer to
acquire data of an image;
recognize a product in the image by using the data of the image;
recognize, using a feature value of an exterior of at least on of each of payment media and/or point accumulation media used to accumulate a point in accordance with payment which are registered in the at least one memory and the data of the image, at least one of a payment medium and a point accumulation medium in the image;
perform a payment process using the recognition result; and
recognize both of the product and at least one of the payment medium and the point accumulation medium when the image includes both of the product and at least one of the payment medium and the point accumulation medium.

10. The information processing apparatus according to claim 2,
wherein the same design is put on the same kind of point accumulation medium in a viewable manner, and unique specific information is attached to each of a plurality of point accumulation media of the same kind in a viewable manner,
wherein a feature value of the design of each kind of point accumulation medium is registered in the at least one memory,
wherein the at least one processor is further configured to recognize the kind of the point accumulation medium and the specific information.

11. The information processing apparatus according to claim 4,
wherein the at least one processor is further configured to:
subtract the amount of the gift voucher from a sum of registered payment amounts of products to calculate a balance amount; and
display the balance amount on the customer display.

12. The information processing apparatus according to claim 5,
wherein the at least one processor is further configured to:
subtract the amount of the gift voucher from a sum of registered payment amounts of products to calculate a balance amount; and
display the balance amount on the customer display.

13. The information processing apparatus according to claim 6,
wherein the at least one processor is further configured to:
subtract the amount of the gift voucher from a sum of registered payment amounts of products to calculate a balance amount; and
display the balance amount on the customer display.

14. The information processing apparatus according to claim 2,
wherein the at least one processor is further configured to:
recognize valid periods of the payment medium or the point accumulation medium by using the recognized text information; and
display information indicating overdue on the customer display, when the recognized valid period is overdue.

15. The information processing apparatus according to claim 3,
wherein the at least one processor is further configured to:
recognize valid periods of the payment medium or the point accumulation medium by using the recognized text information; and
display information indicating overdue on the customer display, when the recognized valid period is overdue.

16. The information processing apparatus according to claim 6,
wherein the at least one processor is further configured to:
recognize valid periods of the recognized discount coupons by using the recognition result; and
display information indicating overdue on the customer display, when the recognized valid period is overdue.

17. The information processing apparatus according to claim 7,
wherein the at least one processor is further configured to:
recognize valid periods of the recognized discount coupons by using the recognition result; and
display information indicating overdue on the customer display, when the recognized valid period is overdue.

18. The information processing apparatus according to claim 1,
wherein the at least one processor is further configured to output a guide for placing the medium using text information.

19. The information processing apparatus according to claim 1,
wherein the at least one processor is further configured to project an image related to an accounting process to at least one of a placement surface of a placement stand and the product.

20. The information processing apparatus according to claim 1,
wherein the at least one processor is further configured to project a guide for placing the medium using text information
